(19) United States
(12) Patent Application Publication
(10) Pub. No.: US 2009/0026172 A1
(43) Pub. Date: Jan. 29, 2009

(54) DRY ETCHING METHOD AND DRY ETCHING APPARATUS

(76) Inventors: Masaki KITABATA, Toyama (JP); Shin-ichi Imai, Osaka (JP)

Correspondence Address: MCDERMOTT WILL & EMERY LLP, 600 13TH STREET, NW, WASHINGTON, DC, 20005-3096, US

(21) Appl. No.: 12/180,118

(22) Filed: Jul. 25, 2008

(30) Foreign Application Priority Data
Jul. 26, 2007 (JP) 2007-194214

(51) Int. Cl. B44C 1/22

(52) U.S. Cl. 216/84; 156/345.25

(57) ABSTRACT

In the dry etching method and dry etching apparatus relating to the present invention, high frequency electric power is applied to upper and lower electrodes from high frequency power sources to generate plasma and etch an object on the electrode in a vacuum chamber into which a process gas is introduced via a gas inlet and the interior of which is maintained for a specific pressure by an exhaust unit. An etching rate estimation equation is created using apparatus parameters including an emission intensity ratio obtained by dividing an emission intensity of a plasma emission wavelength by an emission intensity of an inert gas. An estimated etching rate is calculated using the etching rate estimation equation. An estimated etching time to achieve a proper etching quantity is calculated based on the estimated etching rate and used for the control, reducing the production variation of fine devices.

### CROSS-REFERENCE TO RELATED APPLICATION

The present application claims the benefit of Japanese Patent Application No. 2007-194214 filed Jul. 26, 2007, the subject matter of which is incorporated herein by reference.

### BACKGROUND OF THE INVENTION

1. Field of the Invention

The present invention relates to a dry etching method and dry etching apparatus for etching using plasma.

2. Description of the Related Art

A parallel-plate type dry etching apparatus, one of the prior art dry etching apparatuses, is described hereafter, with reference to FIG. 10.

In FIG. 10, a vacuum chamber 1 is a processing chamber in which the interior is vacuumed by an exhaust unit 11. When the etching operation starts, the vacuum chamber 1 is maintained at a constant inner pressure by the exhaust unit 11 while process gas is introduced through a gas inlet 5. High frequency electric power is supplied to an upper electrode 2 from an upper high frequency power source 7 via an upper electric power matching network 6. High frequency electric power is supplied to a lower electrode 4 from a lower high frequency power source 10 via a lower electric power matching network 9. An object 3 is etched by plasma generated by the electric field created between the upper and lower electrodes 2 and 4. As the etching operation proceeds, a predetermined etching time elapses or the emission intensity of an emission detector 8 reaches a predetermined threshold, and the etching operation ends.

During the etching operation, parameters for the control of the dry etching apparatus, such as the high frequency electric powers, pressure in the vacuum chamber 1, gas flow rate, capacitance of the upper and lower power source matching networks 6 and 9, are monitored. It is assumed that the dry etching apparatus has undergone an abnormal event when any of the apparatus parameters falls outside their predetermined range. An interlock system is used to stop the operation of the dry etching apparatus when an abnormal event is assumed, minimizing the occurrence of defective products.

In order to improve the detection of the etching reaction state and apparatus condition, Japanese Laid-Open Patent Publication No. H08-298259 discloses a technique to monitor the emission intensities of plasma emission wavelengths specific to the etching film of the object 3, photoresist, and etching gas using multiple emission detectors 8. In this technique, the etching rate and selectivity of the etching film and underlying film are calculated based on changes in the emission intensity to determine the etching state and correct the etching state.

Conversely, Japanese Laid-Open Patent Publication No. 2003-23001 discloses a technique to collect a fundamental wave and harmonic wave of a current, voltage and phase difference of the apparatus by means of a data collection unit 13 connected to an apparatus control unit 12, store the collected data (apparatus parameters) in a data storage unit 14, and use the data to pre-create a correlation equation to the etching rate. With this technique, a calculator 15 calculates the etching rate based on the fundamental wave and harmonic wave of the current, voltage and phase difference detected during the etching operation to monitor the etching state and control the etching quantity or etching depth.

### SUMMARY OF THE INVENTION

In the prior art technique described in the prior publication, the plasma emission intensity is detected through a window provided to the vacuum chamber 1. The inner surface of the window is exposed to the plasma state reactive atmosphere and reaction products adhering, wherein the transmittance of light through the window is subject to changes along with the operation condition and time. Signals from the emission detectors 8 provided outside the vacuum chamber 1 for detecting the plasma emission intensity are subject to changes along with the operation condition and the passage of time. Because of changes over time, it is significantly difficult to calculate the etching rate and correct the etching condition based on the plasma emission intensity in a stable manner over a prolonged period.

Furthermore, it is difficult to detect the end point based on changes in the plasma emission intensity as in the prior art in cases where the etching operation is stopped in the middle of the etching film before it is completely removed such as in trench etching for STI (shallow trench isolation) and damascene processing.

In the prior publication, a correlation equation between the fundamental wave and harmonic wave of the current, voltage and phase difference of the apparatus and the etching rate is pre-created to calculate the etching rate based on the fundamental wave and harmonic wave of the current, voltage and phase difference detected during the etching operation. The values of the fundamental wave and harmonic wave of the current, voltage and phase difference are subject changes when the processing chamber is subject to impedance changes because of maintenance service or parts replacement. Therefore, sufficient accuracy and reproducibility acceptable to mass production cannot be obtained unless the etching rate estimation equation to be pre-created is created after each maintenance service or parts replacement.

Maintenance service or parts replacement generally causes the condition of reaction products adhered on the parts or the assembly of the parts to change, altering the apparatus condition and changing the influence of the apparatus parameters on the etching rate. Consequently, even if the estimated etching rate and actual etching rate correlate well under the current maintenance condition, the correlation coefficients may deteriorate after maintenance service.

A possible factor for the above problem is that the apparatus parameters used to create the etching rate estimation equation do not include an apparatus parameter to predict the described maintenance service related conditional changes. For example, the plasma emission intensity is one of the apparatus parameters to monitor the conditional change of the dry etching apparatus. The plasma emission intensity is detected through a window provided to the vacuum chamber. The transmittance of light through the window is subject to changes according to the adhesion condition of reaction products during the etching operation. Consequently, signals from the emission detectors provided outside the vacuum chamber for detecting the plasma emission intensity is subject to changes along with the operation condition and time. In this way, the absolute value of the plasma emission intensity is influenced not only by changes in the apparatus condition but also by the window condition. It is difficult to use the plasma emission intensity in the etching rate estimation equation in its existent state.

The present invention is directed to resolve the above prior art problem and by providing a dry etching method and dry etching apparatus capable of accurately calculating the etching rate in a mass production apparatus and realizing the etching operation with a specific etching quantity or etching depth.

In order to achieve the above purpose, the present invention utilizes the following technical means. First, the present invention is premised upon a dry etching method for plasma etching an object placed in a vacuum chamber maintained for a specific atmosphere and pressure. In the dry etching method of the present invention, an etching rate estimation equation presenting a relationship between multiple apparatus parameters and an etching rate is obtained based on the multiple apparatus parameters and etching rate respectively obtained from multiple etching operations, the multiple apparatus parameters including as one of the apparatus parameters an emission intensity ratio obtained by dividing a spectral intensity of a specific wavelength of light emitted from plasma by a spectral intensity of a wavelength of a specific inert gas emitted from the plasma during the etching operation. An estimated etching rate is calculated using the etching rate estimation equation to determine whether the apparatus undergoes any abnormal event based on the calculated estimated etching rate.

In this dry etching method, for example, the apparatus is assumed to undergo some abnormal event when the calculated estimated etching rate falls outside a predetermined range. Alternatively, an estimated etching depth is calculated using the calculated estimated etching rate and an etching time of a preceding etching operation that has completed and the apparatus is assumed to undergo some abnormal event when the calculated estimated etching depth falls outside a predetermined range.

Furthermore, in another dry etching method of the present invention, an etching rate estimation equation presenting a relationship between multiple apparatus parameters and an etching rate is obtained based on the multiple apparatus parameters and etching rate respectively obtained from multiple etching operations, the multiple apparatus parameters including as one of the apparatus parameters an emission intensity ratio obtained by dividing a spectral intensity of a specific wavelength of light emitted from plasma by a spectral intensity of a wavelength of a specific inert gas emitted from the plasma during the etching operation. An estimated etching rate is calculated using the etching rate estimation equation. An estimated etching time is calculated based on the calculated estimated etching rate and the etching operation is executed using the calculated estimated etching time.

In the dry etching method, for example, the estimated etching time to achieve a desired etching quantity is calculated using the estimated etching rate. Alternatively, an estimated etching depth is calculated using the estimated etching rate and an etching time of a preceding etching operation that has completed. Then, the estimated etching time to achieve a desired etching depth is calculated using the calculated estimated etching depth.

The above described etching rate estimation equation can be obtained by multiple regression analysis on the etching rate in each etching operation and the averages and standard deviations in each etching operation of the apparatus parameters including the above emission intensity ratio as one of the apparatus parameters.

In another aspect, the present invention provides a dry etching apparatus for plasma etching an object placed in a vacuum chamber maintained for a specific atmosphere and pressure. The dry etching apparatus of the present invention comprises an apparatus control unit directing controls of parts of the dry etching apparatus and an emission detector obtaining a spectral intensity of light emitted from plasma within the vacuum chamber. A data collection unit collects multiple apparatus parameters including as one of the apparatus parameters an emission intensity ratio obtained by dividing a spectral intensity of a specific wavelength of light emitted from the plasma by a spectral intensity of a wavelength of a specific inert gas emitted from the plasma, the spectral intensities being obtained by the emission detector during the etching operation. The apparatus parameters collected by the data collection unit are stored in a data storage unit. An etching rate calculator calculates an estimated etching rate using the apparatus parameters stored in the data storage unit and an etching rate estimation equation obtained in advance based on the multiple apparatus parameters and etching rate respectively obtained from multiple etching operations and presenting a relationship between the multiple apparatus parameters and etching rate. The etching rate calculator also calculates an estimated etching time to achieve a desired etching quantity using the calculated estimated etching rate and informs the apparatus control unit of the calculated estimated etching time.

The dry etching apparatus may further comprise an abnormal event determination unit to determine whether or not the estimated etching rate calculated by the etching rate calculator falls within a predetermined range and instructing the apparatus control unit to stop the operation when it falls outside the predetermined range.

Another dry etching apparatus of the present invention comprises an apparatus control unit directing controls of parts of the dry etching apparatus and an emission detector obtaining a spectral intensity of light emitted from plasma within the vacuum chamber. A data collection unit collects multiple apparatus parameters including as one of the apparatus parameters an emission intensity ratio obtained by dividing a spectral intensity of a specific wavelength of light emitted from the plasma by a spectral intensity of a wavelength of a specific inert gas emitted from the plasma, the spectral intensities being obtained by the emission detector during the etching operation. The apparatus parameters collected by the data collection unit are stored in a data storage unit. An etching rate calculator calculates an estimated etching rate using the apparatus parameters stored in the data storage unit and an etching rate estimation equation obtained in advance based on the multiple apparatus parameters and etching rate respectively obtained in multiple etching operations and presenting a relationship between the multiple apparatus parameters and the etching rate. A depth calculator calculates an estimated etching depth using the estimated etching rate calculated by the etching rate calculator and an etching time of a preceding etching operation that has completed. The depth calculator further calculates an estimated etching time to achieve a desired etching quantity using the calculated estimated etching depth and informs the apparatus control unit of the calculated estimated etching time.

The dry etching apparatus can further comprise an abnormal event determination unit determining whether or not the estimated etching depth calculated by the depth calculator falls within a predetermined range and instructing the apparatus control unit to stop the operation when it falls outside the predetermined range.

The above dry etching method and apparatus calculates the estimated etching rate or estimated etching depth based on apparatus parameters including as one of the apparatus parameters the emission ratio obtained by dividing the emission intensity of an emission wavelength of plasma by the emission intensity of an inert gas. Therefore, the etching rate estimation equation does not need to be created each time there is some conditional change due to maintenance service or parts replacement as in the prior art. Thus, highly accurate etching estimation and reproducibility acceptable to mass production apparatuses can be achieved regardless of the apparatus operation condition or time. Consequently, stable and highly accurate etching operation with the etching rate or etching depth properly controlled can be realized. Furthermore, if the etching operation is not executed with a normal etching rate because of some change in the apparatus condition or plasma state, abnormal events can reliably be detected.

The present invention has the effect that highly accurate etching rate estimation and reproducibility acceptable to mass production apparatuses can be achieved and etching operation with the etching rate or etching depth being properly controlled and with less production variation of fine devices is realized.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic configuration drawing showing a dry etching apparatus in the first embodiment relating to the present invention.

FIG. 2 is a schematic drawing showing changes in the fluorine emission intensity during a silicon oxide film etching operation.

FIG. 3 is a graphical representation showing transition of emission intensity through a period of time including multiple maintenance services and parts replacement.

FIG. 4 is a graphical representation showing the relationship between an estimated etching rate calculated by an etching rate estimation equation and a measured etching rate.

FIG. 5 is a flowchart showing a procedure to determine whether or not an abnormal event based on an estimated etching rate calculated by an etching rate estimation equation.

FIG. 6 is a flowchart showing an etching time feedback control procedure using an estimated etching rate calculated by an etching rate estimation equation.

FIG. 7 is a schematic configuration drawing showing a dry etching apparatus in the second embodiment relating to the present invention.

FIG. 8 is a flowchart showing a procedure to determine an abnormal event based on an estimated value calculated by an etching rate estimation equation and an estimated etching depth obtained based on an etching time from an apparatus control unit.

FIG. 9 is a flowchart showing an etching time feedback control procedure using an estimated etching rate calculated by an etching rate estimation equation and an estimated etching depth obtained based on an etching time from the apparatus control unit.

FIG. 10 is a schematic configuration drawing showing a prior art parallel-plate type dry etching apparatus.

### DETAILED DESCRIPTION OF THE PREFERRED EMBODIMENTS

Embodiments of the present invention will be described in detail hereafter with reference to the drawings.

### First Embodiment

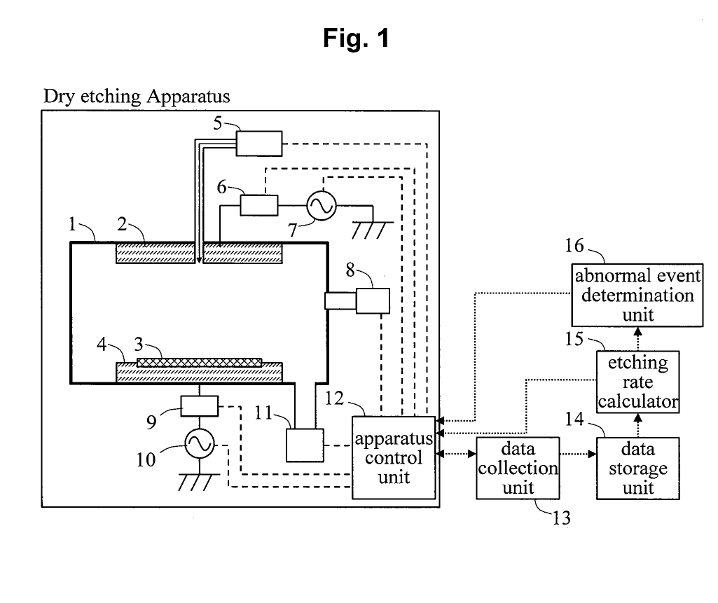

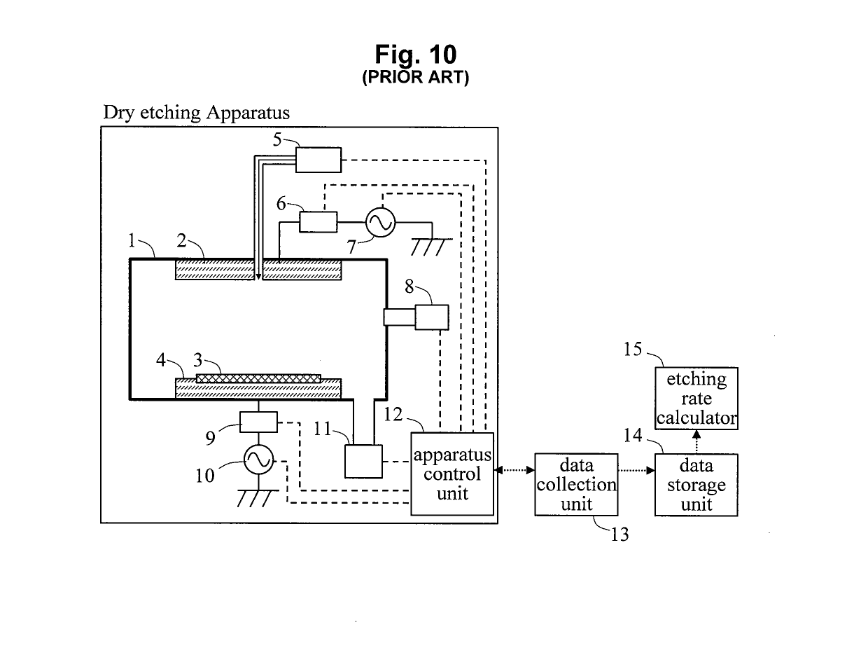

FIG. 1 is a schematic configuration drawing showing a dry etching apparatus in a first embodiment relating to the present invention. Here, components having the functions equivalent to those described with reference to FIG. 10 showing a prior art embodiment are given the same reference numbers and the same is true in the other drawings.

As shown in FIG. 1, a vacuum chamber 1 is provided with an exhaust unit 11 for maintaining the interior thereof in a vacuumed state and achieving a desired pressure by adjusting the opening rate of the valve and a gas inlet 5 for introducing a reactant gas into the vacuum chamber 1. A lower electrode 4 is provided in the vacuum chamber 1 at the bottom. An object 3 such as a semiconductor wafer to be etched is placed and held on the lower electrode 4.

A lower high frequency power source 10 is a power source supplying a high frequency, for example 13.56 MHz, electric power and connected to the lower electrode 4 via a lower power source matching network 9. An upper electrode 2 is provided in the vacuum chamber 1 at the top, facing the lower electrode 4. An upper high frequency power source 7 is a power source supplying a high frequency electric power and connected to the upper electrode 2 via an upper electric power matching network 6. The lower and upper electric power matching networks 9 and 6 each serve to match the resistance (characteristic impedance) within the power source with the resistance (characteristic impedance) following the output of the power source. The power source matching networks 6 and 9 each contain, for example, a variable capacitor and change the capacitance of the variable capacitor to adjust the matching state, stably supplying the output power of the high frequency power source 7 or 10 to the electrode 2 or 4. An emission detector 8 detects emission intensities (spectral intensities) of plasma emission wavelengths specific to the etching film on the object 3, photoresist, and etching gas via a window provided to the vacuum chamber 1.

An apparatus control unit 12 is a control unit directing the controls of parts of the dry etching apparatus. The apparatus control unit 12 obtains apparatus parameters such as the electric powers of the lower and upper high frequency power sources 10 and 7, variable capacitances of the lower and upper power source matching networks 9 and 6, valve opening rate of the exhaust unit 11, and process gas flow rates at the gas inlet 5. The apparatus parameters obtained by the apparatus control unit 12 are not restricted to those described above and can include other apparatus parameters such as electrode temperatures and pressure. The dry etching apparatus of this embodiment further comprises a data collection unit 13, a data storage unit 14, an etching rate calculator 15, and an abnormal event determination unit 16. The data collection unit 13 collects apparatus parameters obtained by the apparatus control unit 12 and stores the collected data in the data storage unit 14. The etching rate calculator 15 calculates an etching rate based on the apparatus parameters stored in the data storage unit 14 and an etching rate estimation equation (described later) obtained in advance. The abnormal event determination unit 16 determines whether or not the estimated etching rate calculated by the etching rate calculator 15 falls within a predetermined specific range and assumes an abnormal event when it falls outside the range. Here, it is preferable that the data collection unit 13 collects the apparatus parameters in each etching operation and stores them in the data storage unit 14.

The dry etching operation using the dry etching apparatus having the above structure will be described hereafter. First, an object 3 is introduced in the vacuum chamber 1 and placed and held on the lower electrode 4. Then, an etching gas containing an inert gas (for example argon (Ar)) and a gas according to the etching film on the object 3 is introduced in the vacuum chamber 1 via the gas inlet 5. Meanwhile, the vacuum chamber 1 is vacuumed by the exhaust unit 11 to maintain a specific atmosphere and pressure in the vacuum chamber 1. Then, a high frequency electric power is applied to the lower electrode 4 from the lower high frequency power source 10 and a high frequency electric power is applied to the upper electrode 2 from the upper high frequency power source 7. The high frequency electric powers applied to the lower and upper electrodes 4 and 2 cause plasma in the gas inside the vacuum chamber 1. The etching film formed on the object 3 is plasma-etched by ions, electrons, and radicals in the plasma. Then, inert gas components and reaction products produced by the etching reaction are exhausted by the exhaust unit 11.

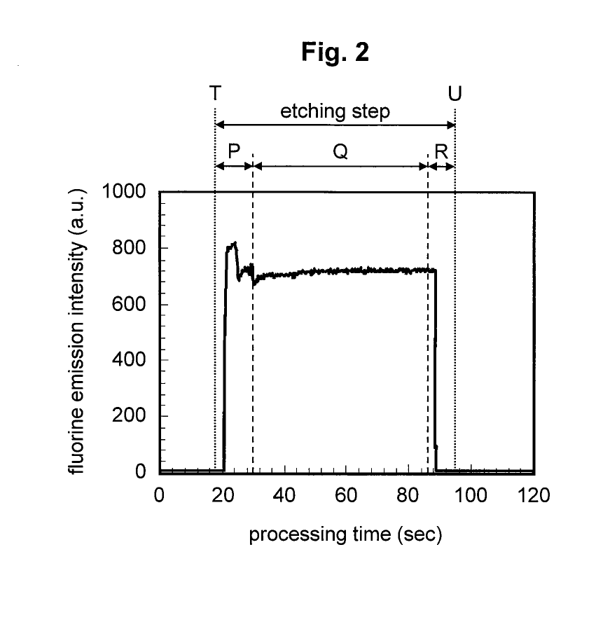

The etching rate estimation equation will be described hereafter using a case that a wafer structure having a silicon oxide film (SiO₂) as the etching film is etched. In such a case, the etching gas can contain, for example, a fluorocarbon gas and an inert gas. FIG. 2 is a schematic drawing showing changes in the fluorine (F) emission intensity (spectral intensity) when a semiconductor wafer having a silicon oxide film is placed on the lower electrode 4 and etched.

In FIG. 2, the etching step starts at a time T and ends at a time U. The fluorine emission intensity is unstable in an interval P of FIG. 2 in which the etching step starts and plasma is ignited and stabilized. The fluorine emission intensity is stable in an interval Q of FIG. 2 in which the etching step is in progress. The fluorine emission intensity is unstable in an interval R of FIG. 2 in which plasma is turned off and the etching step ends. The stable fluorine emission intensity data in the interval Q of FIG. 2 are extracted and the average and standard deviation of the fluorine emission intensity in the interval Q are calculated.

Although no figures are provided, the averages and standard deviations of the apparatus parameters other than the fluorine emission intensity (here, the electric powers of the high frequency power sources, variable capacitances of the power source matching networks, valve opening rate of the exhaust unit, process gas flow rates at the gas inlet) in the interval Q are also calculated using data in the stable interval excluding the start and end of the etching step while the etching operation is performed in the same manner. Furthermore, the etching rate of the silicon oxide film during the etching operation is measured. The etching rate can be calculated for example by measuring the etching quantity of the silicon oxide film using a film thickness measurement system and dividing the etching quantity by the etching time.

Several tens to several hundreds of silicon oxide films are etched and the averages and standard deviations of the apparatus parameter data and the etching rates are calculated in the above procedure. Here, it is desirable to obtain data throughout a period of time including multiple maintenance services and parts replacements.

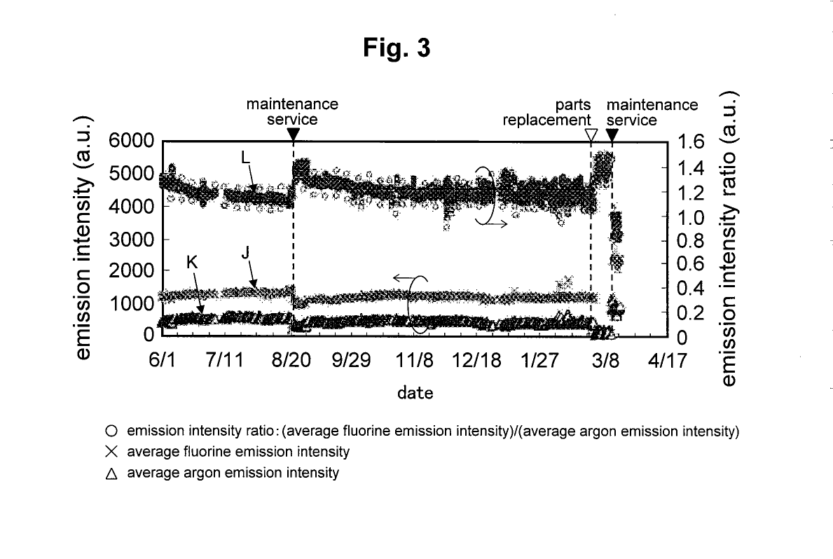

FIG. 3 shows transition of the emission intensity through a period of time including multiple maintenance services and parts replacements. In FIG. 3, data J present transition of an average fluorine emission intensity (spectral intensity) and date K present transition of an average inert gas, argon, emission intensity (spectral intensity). As described above, the transmittance of light through the window changes along with the operation condition and time because of reaction products adhered to the inner surface of the window provided to the vacuum chamber 1; therefore, the absolute values of the fluorine and argon emission intensities change. Data L present an emission intensity ratio obtained by dividing the fluorine emission intensity by the argon emission intensity.

Argon is an inert gas and then the argon emission intensity in the plasma can be an indicator of the change in the transmittance of light through the window provided to the vacuum chamber 1. For example, with the fluorine emission intensity being divided by the argon emission intensity to obtain the emission intensity ratio, the influence of the transmittance of the window is eliminated and the change in the fluorine emission intensity in the plasma is genuinely calculated. The emission intensity data of the etching film, photoresist, and etching gas are similarly divided by the argon emission intensity data to obtain the emission intensity ratios, thereby eliminating the influence of changes in the transmission through the window.

Then, the multiple regression analysis is performed on etching rate measurements and averages and standard deviations of the apparatus parameters such as the electric powers of the high frequency power sources 7, 10, variable capacitances of the power source matching networks 6, 9, valve opening rate of the exhaust unit 11, process gas flow rates at the gas inlet 5, emission intensity ratios each obtained by dividing the emission intensity by the Ar emission intensity, temperatures at places in the vacuum chamber 1. And then, the apparatus parameters necessary for estimating the etching rate are selected. Coefficients for the selected apparatus parameters are determined to create an etching rate estimation equation (1) for calculating the estimated etching rate Y (nm/min).

Y=a₁P₁+a₂P₂+ . . . +aₙPₙ+b₀ (1)

In the equation (1), the coefficients a₁ to aₙ and b₀ are coefficients obtained by the multiple regression analysis. The explanatory variable P₁ to Pₙ are the averages or standard deviations of the apparatus parameters.

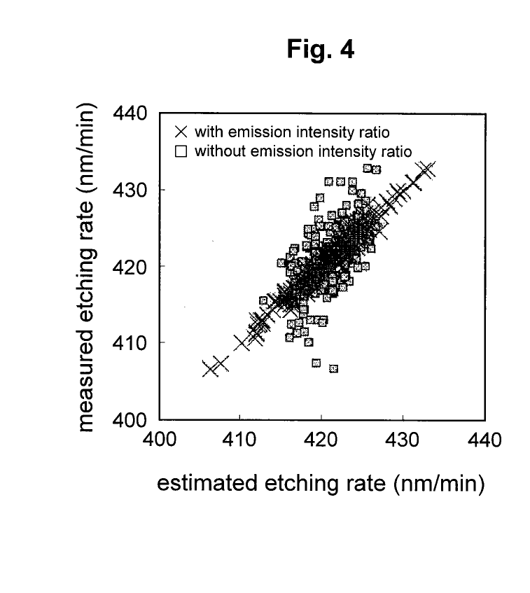

FIG. 4 is a graphical representation showing the relationship between the estimated etching rate calculated by the etching rate estimation equation (1) and the measured etching rate when a silicon oxide film is 200-slice etched. In FIG. 4, the estimated etching rate is plotted as abscissa and the measured etching rate is plotted as ordinate. In FIG. 4, squares present the relationship between the estimated etching rate obtained by the etching rate estimation equation created using the emission intensity ratio obtained by dividing the emission intensity of each wavelength by the argon emission intensity and the measured etching rate. On the other hand, x presents the relationship between the estimated etching rate obtained by the etching rate estimation equation created without using the emission intensity ratio and the measured etching rate. As shown in FIG. 4, the estimated etching rate obtained by the etching rate estimation equation created using the emission intensity ratio has an excellent correlation coefficient of 0.98 with the measured etching rate. Conversely, the estimated etching rate obtained by other apparatus parameters without using the emission intensity ratio has a poor correlation coefficient of 0.54 with the measured etching rate.

As described above, using the etching rate estimation equation created using as explanatory variables multiple apparatus parameters including the emission intensity ratio as one of the apparatus parameters, the etching rate can be estimated with high accuracy. In this embodiment, the data collection unit 13 calculates the average and standard deviation of each apparatus parameter in the interval Q of each etching operation (see FIG. 2) and stores the data in the data storage unit 14. The measured etching rate of each etching operation is also stored in the data storage unit 14. The etching rate calculator 15 yields the etching rate estimation equation using multiple apparatus parameters including the above emission intensity ratio based on the multiple regression analysis on the etching rates and the averages and standard deviations of the apparatus parameters in each etching operation, which are stored in the storage unit 14 in multiple etching operations. The average and standard deviation of the above emission intensity ratio is used as any of the explanatory variables (P₁ to Pₙ) of the equation (1). The other explanatory variables of the equation (1) can appropriately be determined by using a variable selection method such as a stepwise method and the like. The etching rate estimation equation using multiple apparatus parameters including the above emission intensity ratio may be obtained by another calculation device and registered to the etching rate calculator 15. It is preferable that the etching rate estimation equation is obtained for each process gas species introduced in the vacuum chamber 1 or for each object type.

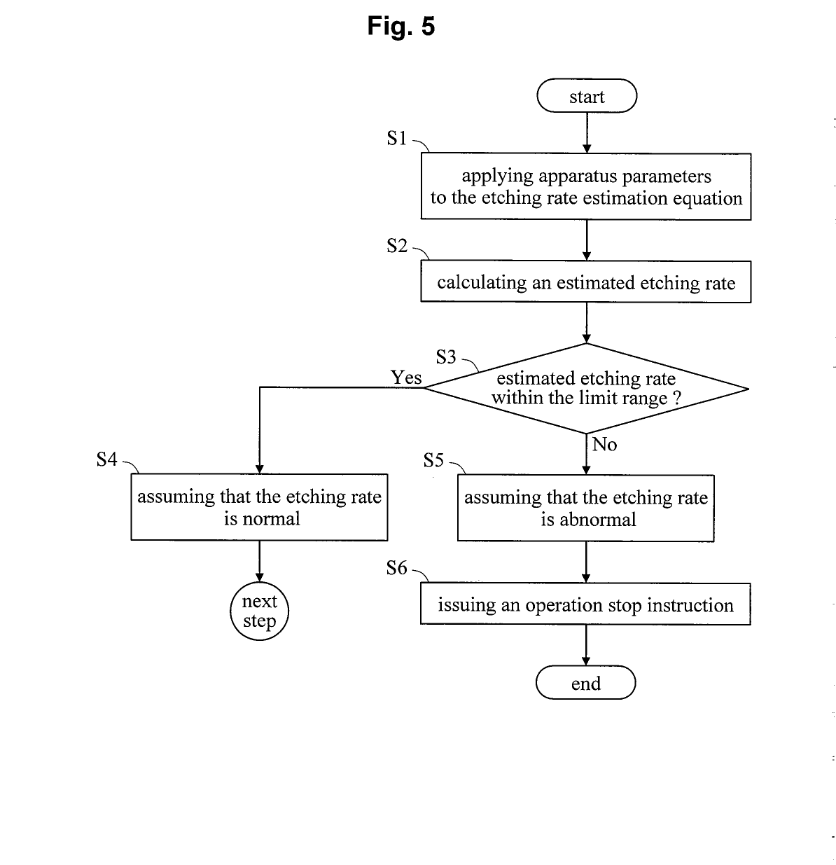

The dry etching operation implemented in the above dry etching apparatus will be described hereafter. FIG. 5 is a flowchart of the procedure to determine whether or not the estimated etching rate calculated by the etching rate estimation equation falls within a normal range in the dry etching apparatus of this embodiment.

First, for example, after the preceding etching operation has completed and before the next etching operation starts, the etching rate calculator 15 obtains from the data storage unit 14 the apparatus parameters collected by the data collection unit 13 during the etching operation and applies them to the etching rate estimation equation using multiple apparatus parameters including the above emission intensity ratio (Step S1) to calculate an estimated etching rate (Step S2). The apparatus parameters are obtained by the data collection unit 13 and stored in the data storage unit 14 as described above. It is particularly preferable that the apparatus parameters obtained from the data storage unit 14 are those obtained in the immediately preceding etching operation.

The etching rate calculator 15 supplies the calculated estimated etching rate to the abnormal event determination unit 16. The abnormal event determination unit 16 is given lower and upper etching rate limits in advance and determines whether the supplied estimated etching rate falls within or outside the range (Step S3). When the supplied estimated etching rate falls outside the range (Step S3 NG), the abnormal event determination unit 16 assumes that the etching rate is abnormal (Step S5). In such a case, the abnormal event determination unit 16 issues an apparatus operation stop instruction to the apparatus control unit 12 to stop the operation of the dry etching apparatus (Step S6). When the supplied estimated etching rate falls within the range, the abnormal event determination unit 16 does not issue an apparatus operation stop instruction, and the dry etching apparatus continues the operation (Steps S3 OK, S4).

In the above structure, the estimated etching rate is calculated using the apparatus parameters including the emission intensity ratio obtained by dividing the emission intensity of a plasma emission wavelength by the emission intensity of an inert gas. Therefore, abnormal events are reliably detected without creating the etching rate estimation equation each time there is some conditional change due to maintenance service or parts replacement as in the prior art. The upper and lower etching rate limits given to the abnormal event determination apparatus 16 can be determined based on a specification value of the etching depth or residual film quantity that is uniquely specified to meet the performance (for example wire resistance) of the device as an etching rate range satisfying the specification value. Alternatively, they can be determined by ±4 sigma based on long-term etching rate management data of the apparatus.

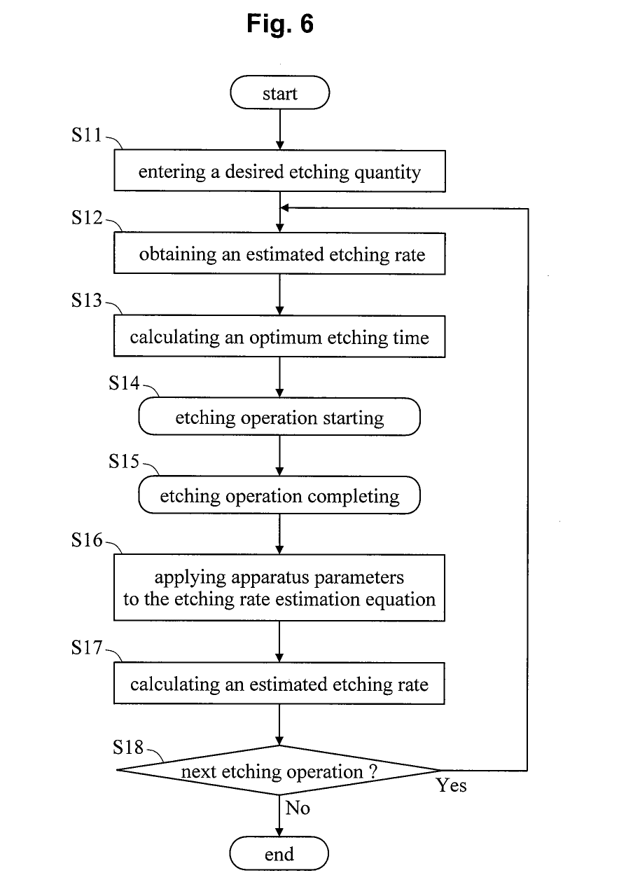

FIG. 6 is a flowchart showing an etching time feedback control procedure using the estimated etching rate calculated by the etching rate estimation equation in order for the dry etching apparatus of this embodiment to achieve a desired etching quantity. First, a user enters a desired etching quantity from an operation panel (not shown) provided to the dry etching apparatus (Step S11). The apparatus control unit 12 supplies the entered etching quantity to the etching rate calculator 15. Meanwhile, the etching rate calculator 15 calculates an estimated optimum etching time using a current estimated etching rate described later (Steps S12, S13).

The etching rate calculator 15 supplies the calculated etching time to the apparatus control unit 12. The apparatus control unit 12 controls the etching operation according to the supplied etching time (Step S14). When the etching operation is over (Step S15), the etching rate calculator 15 obtains from the data storage unit 14 the apparatus parameters including the emission intensity ratio collected by the data collection unit 13 during the etching operation, applies them to the etching rate estimation equation created in advance (Step S16), and calculates an estimated etching rate (Step S17). This estimated etching rate is the current estimated etching rate described above.

Then, the etching rate calculator 15 inquires the apparatus control unit 12 is there is a next etching operation (Step S18). When there is a next operation (Step S18 Yes), the etching rate calculator 15 returns to the Step S12 to calculate an etching time to achieve a desired quantity of the next object 3 to be processed based on the obtained estimated etching rate (the current etching rate) and the desired etching quantity entered for the next object 3 to be processed in the Step S11 as described above. On the other hand, when there is no next operation (Step S18 No), the procedure ends.

In the above structure, the estimated etching rate is calculated using the apparatus parameters including the emission intensity ratio obtained by dividing the emission intensity of a plasma emission wavelength by the emission intensity of an inert gas. Therefore, highly accurate etching rate estimation and reproducibility acceptable to mass production apparatuses can be realized without creating the etching rate estimation equation each time there is some conditional change due to maintenance service or parts replacement as in the prior art.

Consequently, when the etching rate is changed because of some conditional change in the vacuum chamber, the etching time can be controlled according to the change. Therefore, a highly reproducible and accurate etching operation unsusceptible to the dry etching apparatus condition can be realized.

The Steps S16 and S17 in FIG. 6 are the same as the Steps S1 and S2 in FIG. 5. A step of determining whether or not the calculated estimated etching rate falls in the normal range as described with reference to FIG. 5 can be inserted before the Step S18. In such a case, the Step S18 in FIG. 6 will be the step following the Step S4 after the etching rate is determined to be within the normal range in FIG. 5.

In the above, the abnormal event determination unit 16 determines whether the apparatus undergoes any abnormal event in each etching operation. Furthermore, the abnormal event determination unit 16 can monitor chronological changes in the estimated etching rate supplied from the etching rate calculator 15, predict an abnormal event based on the chronological change pattern, and issue a warning. For example, the supplied estimated etching rate is monotonically increasing (or decreasing) in multiple etching operations, the regression line of the chronological change can be obtained to predict when the estimated etching rate falls outside the predetermined range.

### Second Embodiment

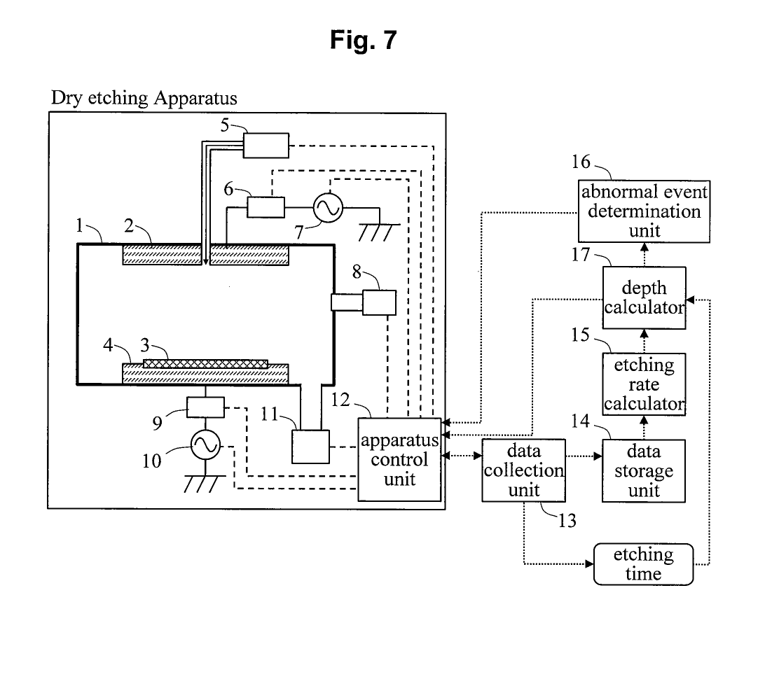

FIG. 7 is a schematic configuration drawing showing a dry etching apparatus in the second embodiment relating to the present invention. The dry etching apparatus of this embodiment comprises a depth calculator 17 provided between the etching rate calculator 15 and abnormal event determination unit 16 for calculating the etching depth in addition to the structure of the first embodiment described above. The overlapping components are not explained here.

The dry etching operation using the dry etching apparatus having the structure shown in FIG. 7 will be described hereafter. In the dry etching apparatus of this embodiment, the etching rate calculator 15 calculates an estimated etching rate using the etching rate estimation equation and apparatus parameters before the etching operation starts. Then, the depth calculator 17 calculates an estimated etching depth by multiplying the preceding etching time (for example, the processing time of the immediately preceding etching operation that has completed) obtained from the apparatus control unit 12 by the estimated etching rate obtained from the etching rate calculator 15. Furthermore, the depth calculator 17 calculates an etching time to achieve an optimum etching depth based on the calculated estimated etching depth and supplies it to the apparatus control unit 12 for the etching operation.

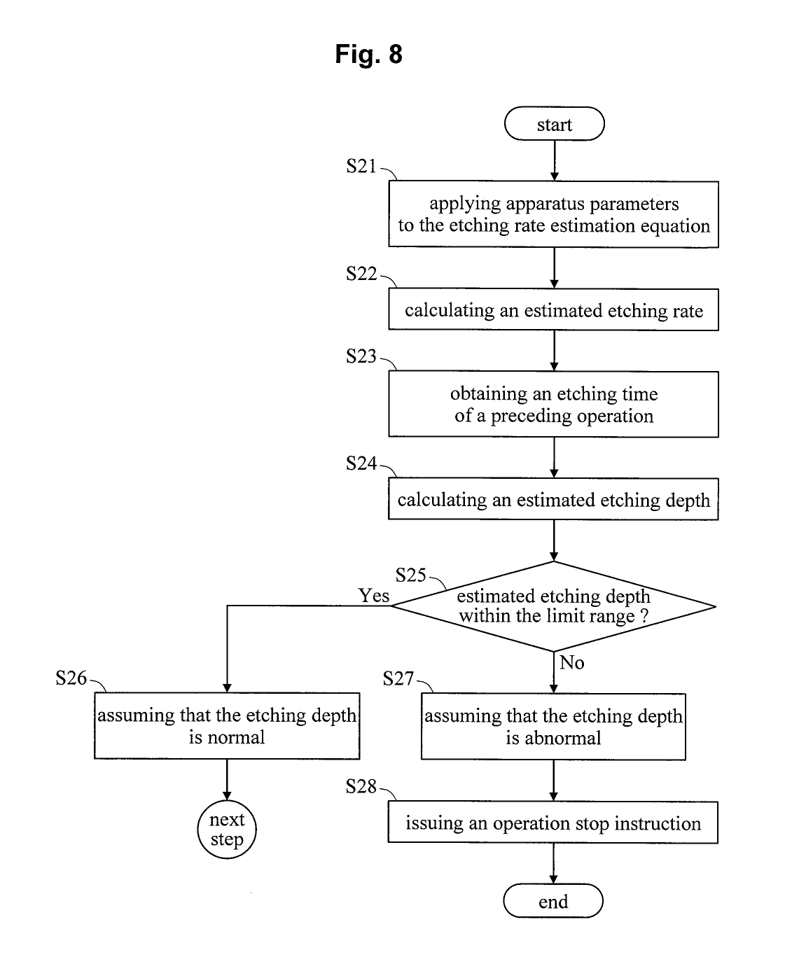

FIG. 8 is a flowchart of the procedure to determine whether or not the estimated etching depth calculated based on the estimated etching rate obtained by the etching rate estimation equation and the etching time from the apparatus control unit 12 is a normal value in the dry etching apparatus of this embodiment.

First, for example, after the completion of the preceding etching operation and before the commencement of the next etching operation, the etching rate calculator 15 applies the apparatus parameters collected by the data collection unit 13 during the etching operation to the etching rate estimation equation using multiple apparatus parameters including the emission intensity ratio described in the first embodiment (Step S21) to calculate the estimated etching rate (Step S22). The etching rate calculator 15 supplies the calculated estimated etching rate to the depth calculator 17. Meanwhile, the depth calculator 17 obtains the etching time of the preceding operation from the data collection unit 13 (Step S23). In this embodiment, the data collection unit 13 obtains the etching time of the preceding etching operation from the apparatus control unit 12. This is not restrictive. Any structure for the depth calculator 17 to obtain the etching time can be used. The depth calculator 17 calculates an estimated etching depth by multiplying the estimated etching rate by the etching time (Step S24). The depth calculator 17 supplies the calculated estimated etching depth to the abnormal event determination unit 16. The abnormal event determination unit 16 is given upper and lower etching depth limits in advance and determines whether or not the supplied estimated etching depth falls within the range (Step S25). When the supplied estimated etching depth falls outside the range (Step S25 NG), the abnormal event determination unit 16 assumes that the etching depth is abnormal (Step S27). In such a case, the abnormal event determination unit 16 issues an apparatus operation stop instruction to the apparatus control unit 12 to stop the operation of the dry etching apparatus (Step S28). When the supplied estimated etching depth falls within the range, the abnormal event determination unit 16 does not issue an apparatus operation stop instruction, and the dry etching apparatus continues the operation (Steps S25 OK, S26).

In the above structure, the estimated etching depth is calculated using the apparatus parameters including the emission intensity ratio obtained by dividing the emission intensity of a plasma emission wavelength by the emission intensity of an inert gas. Therefore, abnormal events are detected reliably without creating the etching rate estimation equation each time there is some conditional change due to maintenance service or parts replacement as in the prior art.

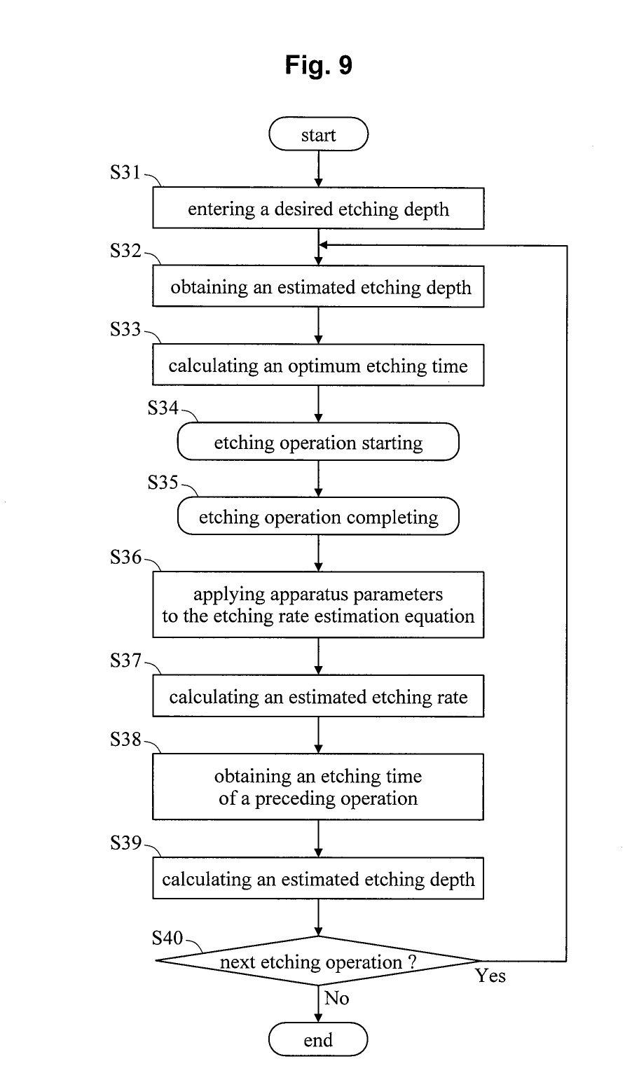

FIG. 9 is a flowchart showing an etching time feedback control procedure using the estimated etching depth calculated based on the estimated etching rate obtained by the etching rate estimation equation and the etching time in order for the dry etching apparatus of this embodiment to achieve a desired etching depth. First, a user enters a desired etching depth from an operation panel (not shown) provided to the dry etching apparatus (Step S31). The etching depth calculator 17 calculates an estimated optimum etching time using a current estimated etching depth obtained based on the current estimated etching rate and the etching time of the preceding etching operation as described later (Steps S32, S33). For example, the desired etching quantity is divided by the current estimated etching depth and multiplied by the etching time of the preceding operation to obtain the optimum etching time. For products to which such a simple calculating formula cannot be applied because of the surface condition or pattern density of an object, the calculating formula to yield the optimum etching time from the current estimated etching depth can be obtained through experiments.

The etching depth calculator 17 supplies the calculated etching time to the apparatus control unit 12. The apparatus control unit 12 controls the etching operation according to the supplied etching time (Step S34). When the etching operation is over (Step S35), the etching rate calculator 15 obtains from the data storage unit 14 the apparatus parameters including the emission intensity ratio collected by the data collection unit 13 during the etching operation, applies them to the etching rate estimation equation created in advance (Step S36), and calculates an estimated etching rate (Step S37). The etching rate calculator 15 supplies the estimated etching rate to the depth calculator 17. Meanwhile, the depth calculator 17 obtains the etching time of the preceding operation that is collected by the data collection unit 13 from the apparatus control unit 12 (Step S38). The depth calculator 17 calculates an estimated etching depth by multiplying the obtained estimated etching rate by the etching time (Step S39). This estimated etching depth is the current estimated etching depth described above.

Then, the etching depth calculator 17 inquires the apparatus control unit 12 as to whether there is a next etching operation (Step S40). When there is a next operation (Step S40 Yes), the etching depth calculator 17 returns to the Step S32 to calculate an etching time to achieve a desired etching depth of the next object 3 to be processed based on the obtained estimated etching rate and the desired etching depth entered for the next object 3 to be processed in the Step S31 as described above. On the other hand, when there is no next operation (Step S40 No), the process ends.

In the above structure, the estimated etching depth is calculated using the apparatus parameters including the emission intensity ratio obtained by dividing the emission intensity of a plasma emission wavelength by the emission intensity of an inert gas. Therefore, highly accurate etching rate estimation and reproducibility acceptable to mass production apparatuses can be realized without creating the etching rate estimation equation each time there is some conditional change due to maintenance service or parts replacement as in the prior art, thereby realizing a highly accurate etching operation.

Furthermore, with the above structure, the etching time is determined based on the estimated etching depth. Therefore, a highly accurate etching operation can be realized even in a process where the etching operation has to be stopped in the middle of the etching film.

Also in FIG. 9, in the same manner as in the first embodiment, the Steps S36 to S39 in FIG. 9 are the same as the Steps S21 to S24 in FIG. 8. The next Step S40 can be executed after it is determined whether or not the estimated etching depth falls within a normal range.

As described above, the present invention provides highly accurate etching rate estimation and reproducibility acceptable to mass production apparatuses. Then, the etching operation can be executed with the etching quantity or etching depth properly controlled and with reduced production variation of fine devices.

The present invention is not confined to the above embodiments. Various modifications and applications are available without departing from the technical scope of the present invention. In the above embodiments, the structure having the abnormal event determination unit is described as a particularly preferable embodiment. However, the structure excluding the abnormal event determination unit also has the efficacy to control the etching quantity with accuracy compared with the prior art. In the above description, the explanatory variables used to yield an etching rate estimation equation are the averages or standard deviations of apparatus parameters. In place of the averages, the maximums, minimums, or intermediate values can be used. In place of the standard deviations, a range (difference between the maximum and minimum values) can be used. The above described estimated etching rate can be obtained for multiple points on the wafer (object). In such a case, the above described abnormal event determination can be performed using the estimated etching rates or estimated etching depths calculated for the respective points or using the average of the estimated etching rates or estimated etching depths calculated for the respective points. The above embodiments are described with reference to a parallel-plate dry etching apparatus by way of example. The present invention is applicable to any dry etching apparatus for plasma etching in a vacuum chamber thereof.

The above described etching rate calculator, depth calculator, and abnormal event determination unit can be realized for example by exclusive-use calculation circuits or by hardware having a processor and a memory such as RAM (Random Access memory) or ROM (Read Only Memory), etc. and software stored in the memory and operating on the processor. Furthermore, the data collection unit, data storage unit, etching rate calculator, depth calculator, and abnormal event determination unit are not necessarily separate units and can be integrated as appropriate.

The dry etching method and dry etching apparatus of the present invention provides highly accurate etching rate estimation and reproducibility acceptable to mass production apparatuses and is useful in etching operation with the etching quantity or etching depth properly controlled and with reduced production variation of fine devices.

What is claimed is:

1. A dry etching method for plasma etching an object placed in a vacuum chamber maintained for a specific atmosphere and pressure, comprising the steps of:
obtaining an etching rate estimation equation presenting a relationship between multiple apparatus parameters and an etching rate based on the multiple apparatus parameters and etching rate respectively obtained from multiple etching operations, the multiple apparatus parameters including as one of the apparatus parameters an emission intensity ratio obtained by dividing a spectral intensity of a specific wavelength of light emitted from plasma by a spectral intensity of a wavelength of a specific inert gas emitted from the plasma during the etching operation;
calculating an estimated etching rate using the etching rate estimation equation; and
determining whether the apparatus undergoes any abnormal event based on the calculated estimated etching rate.

2. A dry etching method according to claim 1, wherein the determining step assumes that the apparatus undergoes some abnormal event when the calculated estimated etching rate falls outside a predetermined range.

3. A dry etching method according to claim 1, wherein the determining step comprises the steps of:
calculating an estimated etching depth using the calculated estimated etching rate and an etching time of a preceding etching operation that has completed; and
assuming that the apparatus undergoes some abnormal event when the calculated estimated etching depth falls outside a predetermined range.

4. A dry etching method according to claim 1, wherein the etching rate estimation equation is obtained by multiple regression analysis on the etching rate in each etching operation and the averages and standard deviations in each etching operation of apparatus parameters including the emission intensity ratio as one of the apparatus parameters.

5. A dry etching method for plasma etching an object placed in a vacuum chamber maintained for a specific atmosphere and pressure, comprising the steps of:
obtaining an etching rate estimation equation presenting a relationship between multiple apparatus parameters and an etching rate based on the multiple apparatus parameters and etching rate respectively obtained from multiple etching operations, the multiple apparatus parameters including as one of the apparatus parameters an emission intensity ratio obtained by dividing a spectral intensity of a specific wavelength of light emitted from plasma by a spectral intensity of a wavelength of a specific inert gas emitted from the plasma during the etching operation;
calculating an estimated etching rate using the etching rate estimation equation;
calculating an estimated etching time based on the calculated estimated etching rate; and
executing the etching operation with the calculated estimated etching time.

6. A dry etching method according to claim 5, wherein the calculating step for the estimated etching time calculates the estimated etching time to achieve a desired etching quantity using the calculated estimated etching rate.

7. A dry etching method according to claim 5, wherein the calculating step for the estimated etching time comprises the steps of:
calculating an estimated etching depth using the estimated etching rate and an etching time of a preceding etching operation that has completed; and
calculating the estimated etching time to achieve a desired etching depth using the calculated estimated etching depth.

8. A dry etching method according to claim 5, wherein the etching rate estimation equation is obtained by multiple regression analysis on the etching rate in each etching operation and the averages and standard deviations in each etching operation of apparatus parameters including the emission intensity ratio as one of the apparatus parameters.

9. A dry etching apparatus for plasma etching an object placed in a vacuum chamber maintained for a specific atmosphere and pressure, comprising:
an apparatus control unit directing controls of parts of the dry etching apparatus;
an emission detector obtaining a spectral intensity of light emitted from plasma within the vacuum chamber;
a data collection unit collecting multiple apparatus parameters including as one of the apparatus parameters an emission intensity ratio obtained by dividing a spectral intensity of a specific wavelength of light emitted from the plasma by a spectral intensity of a wavelength of a specific inert gas emitted from the plasma, the spectral intensities being obtained by the emission detector during the etching operation;
a data storage unit storing the collected apparatus parameters; and
an etching rate calculator calculating an estimated etching rate using the stored apparatus parameters and an etching rate estimation equation obtained in advance based on the multiple apparatus parameters and etching rate respectively obtained from multiple etching operations and presenting a relationship between the multiple apparatus parameters and etching rate, calculating an estimated etching time to achieve a desired etching quantity using the calculated estimated etching rate, and informing the apparatus control unit of the calculated estimated etching time.

10. A dry etching apparatus according to claim 9, further comprising an abnormal event determination unit determining whether or not the estimated etching rate calculated by the etching rate calculator falls within a predetermined range and instructing the apparatus control unit to stop the operation when it falls outside the predetermined range.

11. A dry etching apparatus for plasma etching an object placed in a vacuum chamber maintained for a specific atmosphere and pressure, comprising:
an apparatus control unit directing controls of parts of the dry etching apparatus;
an emission detector obtaining a spectral intensity of light emitted from plasma within the vacuum chamber;
a data collection unit collecting multiple apparatus parameters including as one of the apparatus parameters an emission intensity ratio obtained by dividing a spectral intensity of a specific wavelength of light emitted from the plasma by a spectral intensity of a wavelength of a specific inert gas emitted from the plasma, the spectral intensities being obtained by the emission detector during the etching operation;
a data storage unit storing the collected apparatus parameters;
an etching rate calculator calculating an estimated etching rate using the stored apparatus parameters and an etching rate estimation equation obtained in advance based on the multiple apparatus parameters and etching rate respectively obtained from multiple etching operations and presenting a relationship between the multiple apparatus parameters and the etching rate; and
a depth calculator calculating an estimated etching depth using the estimated etching rate calculated by the etching rate calculator and an etching time of a preceding etching operation that has completed, calculating an estimated etching time to achieve a desired etching quantity using the calculated estimated etching depth, and informing the apparatus control unit of the calculated estimated etching time.

12. A dry etching apparatus according to claim 11, further comprising an abnormal event determination unit determining whether or not the estimated etching depth calculated by the depth calculator falls within a predetermined range and instructing the apparatus control unit to stop the operation when it falls outside the predetermined range.
